(19) United States
(12) Patent Application Publication
(10) Pub. No.: US 2004/0057518 A1
(43) Pub. Date: Mar. 25, 2004

(54) Compression of motion vectors

(76) Inventors: Michael James Knee, Hampshire (GB); Violet Snell, Hampshire (GB)

Correspondence Address: HODGSON RUSS LLP, ONE M & T PLAZA, SUITE 2000, BUFFALO, NY, 14203-2391, US

(21) Appl. No.: 10/381,963

(22) PCT Filed: Oct. 9, 2001
(86) PCT No.: PCT/GB01/04517

(30) Foreign Application Priority Data
Oct. 9, 2000 (GB) 0024709.8
Jan. 24, 2001 (GB) 0101875.3

(51) Int. Cl. H04N 7/12

(52) U.S. Cl. 375/240.16; 348/206

(57) ABSTRACT

In a process for reducing the data rate of motion vector information, the components of the motion vectors are quantised, the quantised values are compressed and transmitted and the quantisation errors are additionally transmitted, whenever sufficient channel capacity is available. When not transmitted, the quantisation errors may be recreated at the encoder receiving the transmission. Where appropriate vectors may be translated to equivalent velocity values and passed through a linear transform, further reducing the required bit capacity.

This invention relates to methods of compressing motion vectors including, for example, the motion vectors that are used in motion compensated video compression schemes such as MPEG-2 and MPEG-4.

One of the key features of MPEG-2 compression is the use of motion compensated prediction, in which blocks of vidoo samples are predicted from other frames or fields that have already been encoded and decoded. Highly efficient compression is achieved by transmitting the prediction error rather than the original samples. The prediction process compensates for the motion between predicted and reference pictures by applying a motion vector to each block. It is then necessary to transmit those motion vectors as part of the compressed bitstream, because the decoder needs to reconstruct the prediction that was made in the encoder. The transmission of motion vectors incurs an inevitable overhead in bit rate. In the MPEG-2 standard, this overhead is reduced by compressing the motion vectors.

The motion vector compression algorithm in the MPEG-2 standard consists of two elements: forming differences between motion vectors in adjacent blocks and transmitting these differences using variable-length coding. This algorithm is a compromise between efficiency and the relatively limited hardware complexity available in an MPEG-2 decoder.

Another application of motion vector compression is in generating a compressed version of a data stream consisting of MPEG-2 coding parameters, formatted in such a way that it can be used to aid MPEG-2 re-encoding of decoded video signals in order to avoid cascading impairments. Reference is directed in this context to WO 98/103017. Such a data stream will herein be referred to as the Information Stream. There is in certain cases a requirement for a compressed version of the Information Stream, because the channel capacity available may be limited. One method of reducing the bit rate of the Information Stream is to use the MPEG-2 syntax itself to transmit the coding parameters. In this case it is sometimes found necessary to reduce th bit rate even further, and this can be done by selectively modifying some motion vectors, as described in WO 99/38327.

It is an object of the present invention to provide improved techniques for the compression of motion vectors.

Accordingly, the present invention consists, in one aspect, in a video signal process, comprising the steps of receiving a picture signal, forming from the picture signal an information signal for use in subsequent encoding of the picture signal, the information signal comprising at least motion vectors, quantising the motion vectors, dividing each of the quantised motion vector values into a part having higher significance and a part having lower significance, transmitting the values such that at a low transmission channel capacity, only the higher significance parts are transmitted, and recreating non-transmitted lower significance parts in a motion vector refinement process utilising the picture signal.

Advantageously, the process comprises transmitting the values such that at a higher transmission channel capacity, both the higher and lower significance parts are transmitted. Suitably, the process comprises separately quantising the respective components of the motion vectors.

Preferably, the process comprises, where the channel is a fixed data channel, the further step of determining the current available capacity of the channel, and transmitting the lower significance part where permitted by the current available capacity. Suitably, the higher significance part comprises a number of more significant bits and the lower significance part comprises a number of less significant bits, as many of the less significant bits being transmitted as the current available capacity of the channel permits.

In another aspect, the invention consists in a process for reducing the data rate of motion vector information, in which the components of the motion vectors are quantised, the quantised values are compressed and transmitted and the quantisati n errors are additionally transmitted, whenever sufficient channel capacity is available.

Advantageously, where the channel is a fixed data channel, the process comprises the further step of determining the current available capacity of the channel, and transmitting the quantisation errors where permitted by the current available capacity.

Suitably, the quantised values comprise a number of more significant bits and the quantisation errors comprise a number of less significant bits, as many of the less significant bits being transmitted as the current available capacity of the channel permits.

In other aspects, the invention may consist in a process for compressing motion vectors, which exploits the correlation of motion vectors horizontally within a picture and in at least one further dimension, preferably vertically.

Advantageously, the motion vectors are compressed using run length coding. Preferably, the motion vectors are scanned using a scanning pattern designed to increase the expected run lengths of quantised motion vectors. Suitably, the quantised vectors are transmitted by run-length encoding in descending order of frequency of occurrence. Advantageously, the frequency of occurrence of vectors is determined separately for each picture. Suitably, both the horizontal and vertical components of each vector are taken in consideration in the determining the frequency of occurrence of vectors.

In another aspect the invention consists in a process for reducing the data rate of motion vector information, in which the motion vectors are run length coded using a scanning pattern designed to increase the expected run lengths.

Preferably, the vectors are transmitted by run-length encoding in descending order of frequency of occurrence. More preferably the frequency of occurrence of vectors is determined separately for each picture. Suitably, both the horizontal and vertical components of each vector are taken in consid rati n in the determining th frequ ncy of occurrence of vectors.

In a further aspect, the invention consists in a process for reducing the data rate of motion vector information, in which the motion vectors are labelled in descending order of frequency of occurr nce and run length encoded. Preferably, the motion vector labels are run-length encod d using a scanning pattern designed to increase the expected run lengths. Suitably, the frequency of occurrence of vectors is determined separately for each picture. Preferably, both the horizontal and vertical components of each vector are taken in consideration in the determining the frequency of occurrence of vectors.

In a still further aspect, the present invention consists in a process for reducing the average data rate of motion vector information, in which the components of the motion vectors are separately or in combination compressed losslessly using a spatial transform followed by a variable-length encoder. Preferably, the transform is a Discrete Cosine Transform.

Advantageously, calculated values are substituted for vectors that do not appear at the input to the process. The calculation may be an average of neighbouring values, or may follow an algorithm that minimizes a measure of the output bit rate.

In a yet further aspect, the invention consists in a process for reducing the average data rate of motion vector information, wherein each region of each picture in a received picture signal has a plurality of motion vectors, each vector associated with a different coding mode, comprising transforming the vectors to equivalent velocity measures and applying a linear transform to the velocity measures.

Preferably, the step of applying a linear transform includes-taking for a region of a picture a representative value of the measures, and comparing the representative value with the measures. More preferably, the representative value is one of the measures. Suitably, the representative value is an average of the measures.

Advantageously, the linear transform is equivalent to forming a prediction and a set of prediction errors.

Suitably, the motion vector information input is the difference between a motion vector and a selected r presentative vector and in which the representative vectors are separately encoded. Preferably, the representative vectors are calculated as a function of the input vectors. More preferably, the representative vectors are calculated as a function of externally provided information such as a vector menu.

In a still further aspect, the present invention consists in a method of compressing motion vectors which derive from a process of motion measurement which comprises the identification of a number of candidate vectors and the preliminary assignment of one or more of said candidate vectors to specific picture elements, the method of compressing comprising the steps of defining said candidate vectors as a set of representative values and quantizing the assigned vectors with reference to said set of representative values.

Preferably, the method comprises the further step of run length coding. Suitably, the method comprises the further steps of noting any error in the quantization of assigned vectors with reference to said set of representative values and additionally coding any such quantization errors.

Another aspect of the invention provides a video signal processor comprising an input for receiving a picture signal, a generator for generating from the picture signal an information signal for use in subsequent encoding of the picture signal, the information signal comprising at least motion vectors, a quantiser for quantising the motion vectors, means for dividing each of the quantised values into a part having higher significance and a part having lower significance, and means for transmitting the values such that at a low transmission channel capacity, only the higher significance parts are transmitted.

Preferably, the processor comprises means for determining the current available capacity of the channel, wherein the lower significance part is transmitted where permitted by the current available capacity.

Suitably, the higher significanc part comprises a number of more significant bits and the lower significanc part compris s a number of less significant bits, as many of the less significant bits being transmitted as the current available capacity of the channel permits.

Advantageously, the processor forms part of a system further comprising a downstream processor adapted to receive the picture signal and the information signal, the downstream processor comprising a motion vector refiner serving to recreating non-transmitted lower significance parts in a refinement process utilising the picture signal.

The invention will now be described by way of example, with reference to the accompanying drawings, in which:

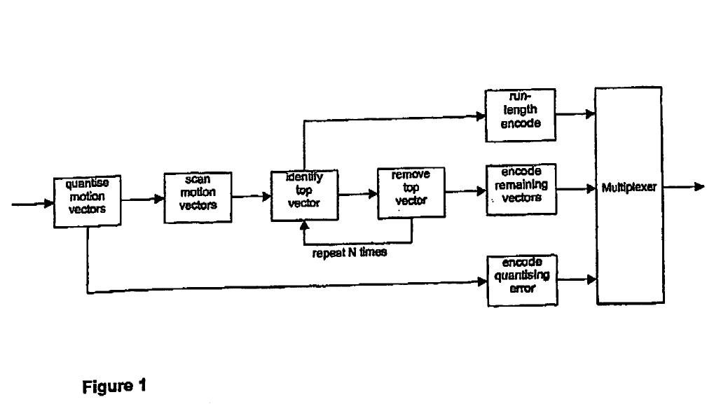

FIG. 1 is a block diagram illustrating one embodiment of the invention;

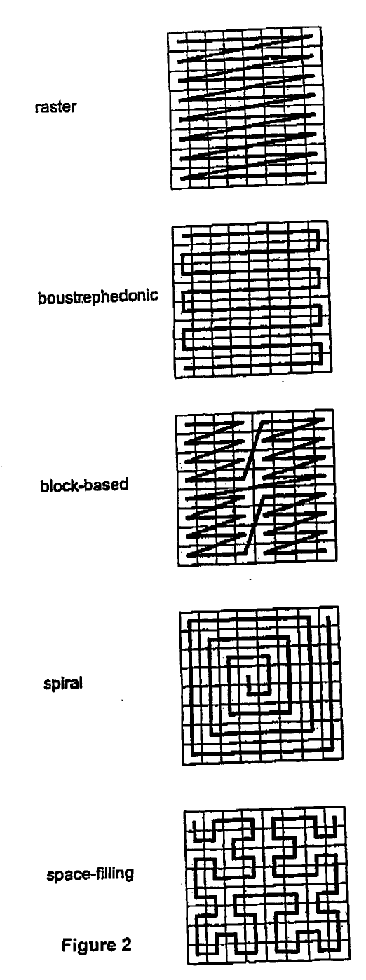

FIG. 2 is a series of diagrams showing examples of scanning patterns for use in the present invention; and

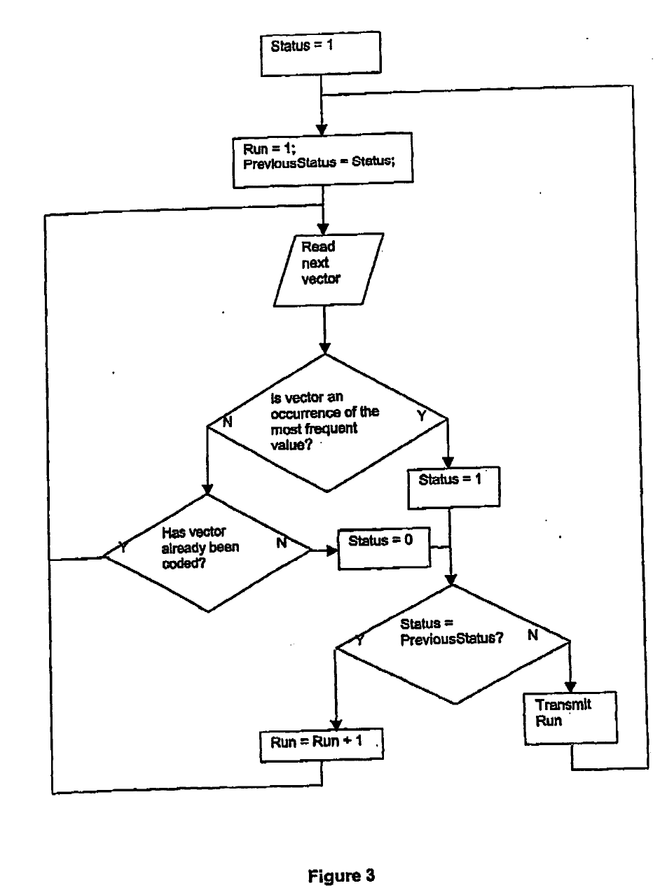

FIG. 3 is a flow chart illustrating a further aspect of the invention.

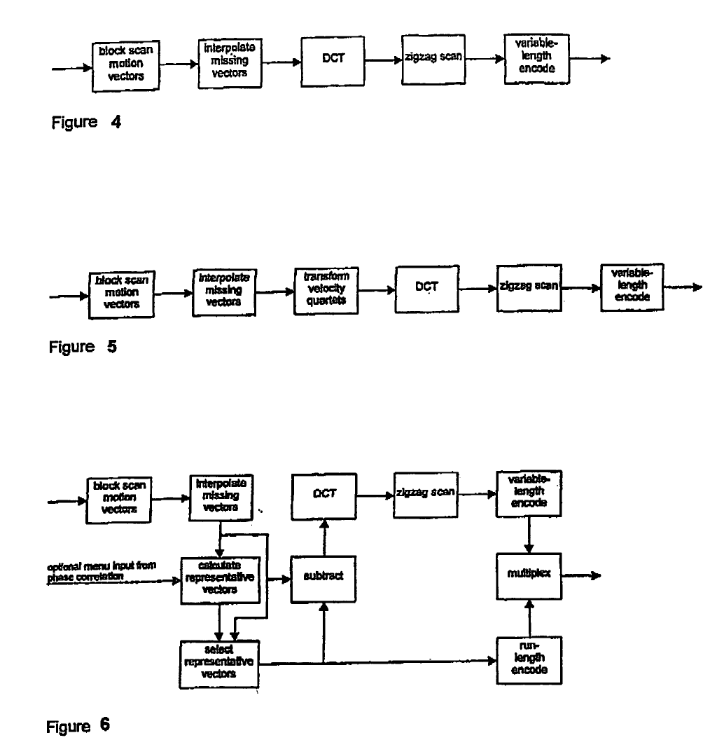

FIGS. 4, 5 and 6 are block diagrams illustrating three further embodiments of the invention.

A motion vector compression technique according to a first embodiment of the invention, which will be described in more detail below, is based on three processing steps (which will have utility alone and in other combinations):

quantising the motion vectors, with transmission of the quantising error only if sufficient bandwidth remains after the quantised vectors have been transmitted,

scanning the motion vectors for run-length coding in such a way as to maximise run-lengths given the two-dim nsional nature of areas of constant quantised motion vectors,

run-length coding of quantised motion vectors, or of labels representing them, in descending order of their frequency of occurrence.

Referring to FIG. 1, the first step is to quantise the motion vectors that are to be encoded. The simplest way to do this is to remove a fixed number (for example, two) of least-significant bits from the two's-complement representation of each component of the vector. If horizontal and vertical component are each represented with 9 bits, the quantisation process would thus reduce the vectors to 14 bits in total. The remaining 14 bits will then be compressed using the techniques described here, while the 4 least-significant bits will be transmitted if sufficient capacity remains in the channel.

The second step is to scan the quantised motion vectors, in such a way as to try to maximise the expected run-lengths of the vectors. Possible scanning patterns include:

straightforward raster (row by row) scanning of the vectors

boustrophedon scanning

block-based scanning

spiral scanning

scanning using a space-filling curve such as the Peano or Hilbert scan

Examples of these patterns are shown in FIG. 2.

Motion vectors, if property measured, will tend for most picture material to vary smoothly across and down a picture. Where vectors are appropriately quantised, there is therefore a relatively high probability that the motion vectors of neighbouring blocks will take the same value. Run length coding along a scan path which connects both horizontally and vertically adjacent blocks, will therefore increase coding efficiency.

The third step is to run-length encode th quantised motion v ctors in order of decreasing frequency of occurrence. For this purpose, the horizontal and vertical components of the vectors are taken together. The vector values are sorted according to their frequency of occurrence within the picture. The occurrences of the most frequent vector are then transmitted in the chosen scanning order using run-length coding, for example using the method shown in FIG. 3. That vector is then removed from the list and the occurrences of the next most frequent vector are in turn transmitted using run-length coding. The process is repeated until one or more of the following conditions is met, the choice being a question of configuration of the system:

a specified number of most frequent vectors from the list have been processed

a specified number of occurrences have been transmitted

the number of vectors represented by the current element in the list falls below a certain value

The remaining quantised vectors are then transmitted in the order in which they occur in the scan, either by variable-length or by fixed-length coding. In extreme circumstances, when the channel capacity is insufficient for these vectors, they are omitted from the bitstream. However, the invention is intended for use when this problem occurs extremely rarely.

Finally, the quantising errors are transmitted-in descending order of bit significance, until the capacity of the channel is reached. The current occupation of the channel is monitored, typically in a buffer through which the bitstream passes, and the least significant bits transmitted when the channel is not completely filled with the MSB data.

It will be noted that FIG. 1 shows a multiplexer at the output of the system. This does not add to the functionality of the invention itself, but merely serves to indicate that the output is formed into a single bitstream.

The bitstream will be received by a downstream decoder. At certain points in the bitstream, the least significant bits of the quantised motion vectors may n t b present. In such cases, the LSBs may be recreated in a refinement process. Such refin ment will typically be similar to common block-matching processes, such as that employed in the MPEG standard to refine or increase the accuracy of a motion vector, involving searching for a match in the vertical directions to a certain error either side of the block. However, the block-matching employed may be simplified, as the value for the most significant bit (the first 7 bits) of the vector will typically be known. Thus to recreate the LSBs (the remaining 2 bits), the block matching need only search in the quadrant indicated by the known MSB, i.e. for a value greater than, and in the direction of, the known vector.

The invention in its various aspects has a number of important advantages. The motion vector compression scheme is very efficient, particularly when the input vectors have high spatial correlation, as is particularly the case when phase correlation is used as the method of motion estimation. The method is scalable in that the most important information is transmitted first.

The division of the motion vector bit rate into 14 MSB's and 4 LSB's is of course only one alternative. The described process of separately run length coding the vectors in order of frequency, has the advantage of enabling information about the least frequent vectors to be discarded first. Other approaches exist including direct run length coding of the quantised vectors along the chosen scan path.

In a further embodiment of the invention, an alternative approach to the compression is to scan the motion vectors in blocks, typically 8×8, and to use a two-dimensional transform such as the DCT to compress the vectors

Reference is directed initially to FIG. 4.

Let us assume that we are encoding motion vectors in a bidirectionally predicted picture (B-picture) according to the MPEG-2 standard. In this case, each macroblock has up to four motion vectors. The diagram shows the process applied to these four vectors in parallel. The horizontal and vertical components of the motion vectors may either be treated separately and encoded independ ntly in parallel, or they may b considered as th real and imaginary parts of a complex number and ncoded together.

The row scanning format of each input vector is first converted to block-based scanning, for example with 8×8 blocks. Note that each 8×8 block of vectors at this stage covers an area corresponding to 8×8 macroblocks, or 128×128 pixels, of the original image.

In the MPEG-2 standard, not every macroblock in a B-picture has all four motion vectors. For example, a particular macroblock might be intra-coded and have no vectors, or forward predicted using one frame vector only, or at the other extreme it may be bidirectionally field-predicted with four vectors. The DCT will require a value for each of its 64 inputs, Where no such value exists, it will be necessary to calculate an interpolated value. This could be done, for example, by simply repeating an adjacent value or by taking an average or median of neighbouring values.

The method then follows the standard MPEG-2 coding process in the application of the transform, zigzag scan and variable-length coding, the main difference being that there is no quantisation because the motion vector compression is intended to be lossless. Both the shape of the zigzag scan and the design of the variablelength coder may be varied from the MPEG-2 standard in order to maximize the efficiency of the algorithm.

In the case of forward predicted pictures (P-pictures), the above description applies but there are only two motion vectors per macroblock. In all cases, the decoding process is a direct reversal of the encoding process and requires no further description.

This embodiment of the present invention offers important advantages of the invention. It offers an efficient method of compressing motion vectors, yet the most computationally intensive processing blocks are already available in a standard MPEG-2 encoder.

An improvement to this method is to exploit the correlation between the four motion vectors of each macroblock. A general way of achieving this is shown in FIG. 5.

For each block (in a B picture) there will be four vectors: forward and backward field-based vectors, denoted v₀ and v₁ respectively, and forward and backward frame-based vectors, denoted v₂ and v₃. The sets of four vectors for each macroblock, referred to here as quartets, are passed through a linear transform in order to reduce their entropy and hence the number of bits needed to encode them. In order to do this efficiently, it is necessary first to compensate for the different time intervals and directions over which the vectors are defined, by calculating the velocity to which each one corresponds, Coding of the transformed quartets is therefore carried out in the velocity domain rather than the displacement domain.

The velocities are calculated as follows. The time frame is taken as the period between fields. Thus, if the forward field-based vector v₀, has components x₀ and y₀, the backward vector v₁ will have components −x₁, −y₁. The frame-based vectors will therefore have twice these values (as they are an extra field further away, temporally). Thus:

v₀=x₀, y₀

v₁=−x₁, −y₁

v₂=2x₂, 2y₂

v₃=−2x₃, −2y₃

The vectors are now all expressed in the velocity domain, and the linear transform is applied. The transform that might be applied to the quartets can be expressed as a 4×4 matrix multiplication. There now follow two examples of suitable transforms between velocities v₁ and transformed velocities z₁;

### EXAMPLE 1

$$( \begin{matrix}{z}_{0} \\ {z}_{1} \\ {z}_{2} \\ {z}_{3}\end{matrix} ) = ( \begin{matrix}1 & 0 & 0 & 0 \\ - 1 & 1 & 0 & 0 \\ - 1 & 0 & 1 & 0 \\ - 1 & 0 & 0 & 1\end{matrix} ) ( \begin{matrix}{v}_{0} \\ {v}_{1} \\ {v}_{2} \\ {v}_{3}\end{matrix} )$$

Here, the first velocity in the quartet is taken as a prediction and the other three vectors are encoded as prediction errors with respect to the first velocity.

### EXAMPLE 2

$$( \begin{matrix}{z}_{0} \\ {z}_{1} \\ {z}_{2} \\ {z}_{3}\end{matrix} ) = ( \begin{matrix}0.25 & 0.25 & 0.25 & 0.25 \\ - 0.25 & 0.75 & - 0.25 & - 0.25 \\ - 0.25 & - 0.25 & 0.75 & - 0.25 \\ - 0.25 & - 0.25 & - 0.25 & 0.75\end{matrix} ) ( \begin{matrix}{v}_{0} \\ {v}_{1} \\ {v}_{2} \\ {v}_{3}\end{matrix} )$$

In the second example, a prediction is formed by taking the average of the four velocity values and three of the vectors are encoded as prediction errors with respect to that average value.

Further variations to the these examples of the invention are possible. For example, another transform might be used instead of the 8×8 DCT. For example, a DCT with larger blocks (up to and including the whole picture), a Discrete Fourier Transform (DFT) or any other linear transform known in the art. The spatial transform and the transform used on the vector quartets may be combined in one single linear operation. The values assigned to non-existent motion vectors may be calculated in such a way as to minimize the energy or entropy of the transform output, or some other estimate of the output bit-rate.

It will be understood that the techniques of transforming the vectors into the velocity domain may be employed to advantage on a greater (or smaller) scale than the macroblock.

It should also be noted that techniques other than spatial transforms and run length coding may be employed to exploit the correlation of motion vectors horizontally and vertically within a picture. It will for example be convenient to employ two dimensional predictive coding of motion vectors.

The methods so far described exploit correlation between vectors within a picture but do not make any reference to vectors in preceding or subsequent pictures. This is important in an application such as a compressed Information Stream, where the information for each picture is required to stand alone. However, if that independence is not required, the method can work by encoding inter-frame differences between motion vectors, or by some other method involving inter-frame prediction. Again, the vectors can be normalised according to velocity. Where it is desired to use methods that do not involve spatial transforms, the exploitation of motion vector correlation horizontally, vertically arid temporally can be combined in a three-dimensional predictive coding scheme for motion vectors,

The examples of the invention so far described can be used in conjunction with any motion estimation scheme. However, the choice of motion estimation scheme will have a substantial bearing on the efficiency of the invention. For example, some motion estimation schemes based on block matching, as described for example in the MPEG Test Model [ISO/IEO, 1996. Information technology—generic coding of moving pictures and associated audio information: Software simulations. International standard ISO/IEO 13818-5], produce a motion vector field that typically has large variations between adjacent macroblocks. Such schemes can lead to a high motion vector bit rate when the vectors are encoded according to the MPEG standard, and even with the increased efficiency offered by the invention the resulting bit rate might still be relatively high. If, however, a motion estimation scheme that measures more accurately the highly correlated true motion of the picture sequence is used, the bit rate of the compressed motion vectors may be much lower. Such a motion estimation scheme is phase correlation [described in Lau, H and Lyon, D. Motion compensated processing for enhanced slow-motion and standards conversion. IBC, Amsterdam, 1992. IEE Conference Publication no. 358, pp 62-66] and applied to MPEG coding via techniques known as vector tracing and vector refinement [Thomas, G and Dancer. S. Improved motion estimation for MPEG coding within the RACE ‘COUGAR’ project. IBC, Amsterdam, 1995. IEE Conference Publication no. 413, pp 238-243J.

There now follows a description of a further improvement to the previous embodiment of the invention, which is particularly appropriate when a motion estimation scheme such as phase correlation is used. The first part of the phase correlation technique is to generate a small “menu” containing only two or three different velocities, from which the velocities for each pixel in a large region of the image are selected. These velocities are then converted to vectors suitable for MPEG encoding by the vector tracing and vector refinement processes. It follows that the MPEG vectors will usually be clustered around a few distinct velocities corresponding to the original phase correlation menus.

This improved method uses the well-known technique of vector quantisation to encode suitable representative velocities, followed by the DCT technique described above to encode residual errors between the representative vectors and the actual vectors.

A block diagram of the improved technique is shown in FIG. 6: For each picture or picture region, a set of representative vectors is calculated. In the general case, this is done using the input vectors themselves, using a vector quantization codebook generation technique such as the Linde-BuzO-Grey algorithm [Y. Linde, A. Buzo and R. M. Gray, “An algorithm for vector quantizer design”, IEEE Trans. on Commun., Vol. COM-28, No. 1, pp. 84.95, January 1980]. In the specific case that the vectors are known to originate from phase correlation, the menu vectors themselves can be used in the calculation of representative vectors.

Each vector is then compared to the set of representative vectors and the nearest one chosen. The output of this stage is typically constant over objects or regions in the picture, and hence may efficiently be encoded using a run-length encoding technique. M anwhile, in order to achieve lossless encoding of vectors, the selected repres ntativ vectors are subtracted from the actual vectors and the resulting errors passed through the existing coding algorithm.

It will be recognised that this technique may be employed independently of the spatial transform of motion vectors and will offer particular advantage where the motion measurement technique operates—as in phase correlation—to identify a number of candidate vectors and then to assign one or more of said candidate vectors to specific picture elements. Those picture elements may be pixels or blocks. The assignment may be preliminary in that actual vectors are refined to increase accuracy. In which case, there is the option of noting any quantization error and additionally coding it such that the scheme remains lossless. Still other modifications will occur to those skilled in the art.

It should be understood that the invention has been described by way of example only and that a wide variety of modifications are possible without departing from the scope of the invention.

1. A video signal process, comprising the steps of receiving a picture signal, forming from the picture signal an information signal for use in subsequent encoding of the picture signal, the information signal comprising at least motion vectors, quantising the motion vectors, dividing each of the quantised motion vector values into a part having higher significance and a part having lower significance, transmitting the values such that at a low transmission channel capacity, only the higher significance parts are transmitted, and recreating non-transmitted lower significance parts in a motion vector refinement process utilising the picture signal.

2. A process according to claim 1, further comprising transmitting the values such that at a higher transmission channel capacity, both the higher and lower significance parts are transmitted.

3. A process according to claim 1 or claim 2, further comprising separately quantising the respective components of the motion vectors.

4. A process according to any of the above claims, where the channel is a fixed data channel, comprising the further step of determining the current available capacity of the channel, and transmitting the lower significance part where permitted by the current available capacity.

5. A process according to claim 4, in which the higher significance part comprises a number of more significant bits and the lower significance part comprises a number of less significant bits, as many of the less significant bits being transmitted as the current available capacity of the channel permits.

6. A process for reducing the data rate of motion vector information, in which the components of the motion vectors are quantised, the quantised values are compressed and transmitted and the quantisation errors are additionally transmitted, whenever sufficient channel capacity is available.

7. A process according to claim 6, where the channel is a fixed data channel, comprising the further step of determining the current available capacity of the channel, and transmitting the quantisation errors where permitted by the current available capacity,

8. A process according to claim 7, in which the quantised values comprise a number of more significant bits and the quantisation errors comprise a number of less significant bits, as many of the less significant bits being transmitted as the current available capacity of the channel permits.

9. A process according to any of the above claims, in which the motion vectors are compressed using run length coding.

10. A process according to any of the above claims, in which the motion vectors are scanned using a scanning pattern designed: to increase the expected run lengths of quantised motion vectors.

11. A process according to any of the above claims, in which the quantised vectors are transmitted by run-length encoding in descending order of frequency of occurrence.

12. A process according to claim 11, in which the frequency of occurrence of vectors is determined separately for each picture.

13. A process according to claim 11 or claim 12, in which both the horizontal and vertical components of each vector are taken in consideration in the determining the frequency of occurrence of vectors.

14. A process for reducing the data rate of motion vector information, in which the motion vectors are run length coded using a scanning pattern designed to increase the expected run lengths.

15. A process according to claim 14, in which the vectors are transmitted by run-length encoding in descending order of frequency of occurrence.

16. A process according to claim 15, in which the frequency of occurrence of vectors is determined separately for each picture.

17. A process according to claim 15 or claim 16, in which both the horizontal and vertical -components of each vector are taken in consideration in the determining the frequency of occurrence of vectors.

18. A process for reducing the date rate of motion vector information, in which the motion vectors are labelled in descending order of frequency of occurrence and run length encoded.

19. A process according to claim 18, in which the motion vector labels are run-length encoded using a scanning pattern designed to increase the expected run lengths.

20. A process according to claim 18 or claim 19, in which the frequency of occurrence of vectors is determined separately for each picture.

21. A process according to claim 20, in which both the horizontal and vertical components of each vector are taken in consideration in the determining the frequency of occurrence of vectors.

22. A process for reducing the average data rate of motion vector information, in which the components of the motion vectors are separately or in combination compressed losslessly using a spatial transform followed by, a variablelength encoder.

23. A process according to claim 22, in which the transform is a Discrete Cosine Transform.

24. A process for reducing the average data rate of motion vector information, wherein each region of each picture in a received picture signal has a plurality of motion vectors, each vector associated with a different coding mode, comprising transforming the vectors to equivalent velocity measures and applying a linear transform to the velocity measures.

25. A process according to claim 24, wherein the step of applying a linear transform includes taking for a region of a picture a representative value of the measures, and comparing the representative value with the measures.

26. A process according to claim 25, wherein the representative value is on of the measures.

27. A process according to claim 25, wherein the repr sentative value is an average of the measures.

28. A process according to claim 24, in which the linear transform is equivalent to forming a prediction and a set of prediction errors.

29. A process according to any of the preceding claims, in which the motion vector information input is the difference between a motion vector and a selected representative vector and in which the representative vectors are separately encoded.

30. A process according to claim 29, in which the representative vectors are calculated as a function of the input vectors.

31. A process according to claim 30, in which the representative vectors are calculated as a function of externally provided information such as a vector menu.

32. A method of compressing motion vectors which derive from a process of motion measurement which comprises the identification of a number of candidate vectors and the preliminary assignment of one or more of said candidate vectors to specific picture elements, the method of compressing comprising the steps of defining said candidate vectors as a set of representative values and quantizing the assigned vectors with reference to said set of representative values.

33. A method according to claim 32, comprising the further step of run length coding.

34. A method according to claim 32 or claim 33, comprising the further steps of noting any error in the quantization of assigned v ctors with reference to said set of representative values and additionally coding any such quantization errors.

35. A video signal processor comprising an input for receiving a picture signal, a generator for generating from the picture signal an information signal for use in subsequent encoding of the picture signals, the information signal comprising at least motion vectors, a quantiser for quantising the motion vectors, means for dividing each of the quantised values into a part having higher significance and a part having lower significance, and means for transmitting the values such that at a low transmission channel capacity, only the higher significance parts are transmitted.

36. A processor according to claim 35, further comprising means for determining the current available capacity of the channel, wherein the lower significance part is transmitted where permitted by the current available capacity.

37. A processor according to claim 36, in which the higher significance part comprises a number of more significant bits and the lower significance part comprises a number of less significant bits, as many of the less significant bits being transmitted as the current available capacity of the channel permits.

38. A system comprising a video processor according to any one of claims 35 to 37 and a downstream processor adapted to receive the picture signal and the information signal, the downstream processor comprising a motion vector refiner serving to recreating non-transmitted lower significance parts in a refinement process utilising the picture signal.
